(19) United States
(12) Patent Application Publication
(10) Pub. No.: US 2013/0264523 A1
(43) Pub. Date: Oct. 10, 2013

(54) PIGMENT GRANULES

(71) Applicants: Thomas Rathschlag, Riedstadt (DE); Carsten Griessmann, Gross-Zimmern (DE)

(72) Inventors: Thomas Rathschlag, Riedstadt (DE); Carsten Griessmann, Gross-Zimmern (DE)

(73) Assignee: MERCK PATENT GMBH, Darmstadt (DE)

(21) Appl. No.: 13/994,167

(22) PCT Filed: Nov. 17, 2011
(86) PCT No.: PCT/EP2011/005809

§ 371 Date: Jun. 14, 2013

(30) Foreign Application Priority Data
Dec. 16, 2010 (DE) 10 2010 054 803.0

(51) Int. Cl. H01B 1/08; C09D 5/24; C08K 3/22

(52) U.S. Cl. CPC H01B 1/08; C08K 3/2279; C09D 5/24
USPC 252/502; 252/500; 252/518.1; 252/514; 252/520.1; 252/521.3

(57) ABSTRACT

The present invention relates to conductive pigment granules which are distinguished by the fact that they are based on a support material, where the support material has been coated with one or more electrically conductive pigments by means of an adhesion promoter. The pigment granules according to the invention are preferably used in pale surface coatings which have been formed with electrically conductive properties.

The present invention relates to electrically conductive pigment granules and to a process for the production thereof and to the use thereof, for example, in plastic flooring, surface coatings and powder coatings. Furthermore, the invention likewise relates to electrically conductive surface coatings comprising pigment granules of this type.

Dissipative surfaces are usually required in areas where static charging may arise due to friction, the energy of which can be released in the form of electrical discharging. Static charging may arise in all situations where different materials rub against one another. However, discharging of the static charges may result in damage to technical equipment. A frequent form of electrostatic charging is contact charging, for example when walking on floors. The shoe sole, the person and the floor surface can be electrostatically charged in such a way that subsequent contact with a conductive article can result in noticeable spark discharge. This can result in destruction of sensitive equipment and apparatuses. Thus, for example, sensitive equipment in operating rooms can fail and/or be destroyed and thus give incorrect results. Furthermore, discharge can result in an explosion, for example in areas in which explosive gases or dusts occur.

In order to counter possible static charging, dissipative surface coatings or materials can be employed. Thus, dissipative coatings or materials can be used in plastics, fibres and fabrics. A further application example is the use of dissipative floor surfaces in multistorey car parks. Here, a surface covering in which dissipative pigments are embedded in a polymer matrix allows static charges formed to be dissipated from the surface, for example via earthing straps or earthing meshes based on copper.

A measure of the ability to be able to dissipate static discharges of this type is the dissipative capacity. It thus denotes the property of dissipating electrical energy. The magnitude of the dissipative capacity is determined by the resistance of the material, quoted in ohms. The higher the resistance, the lower the dissipative capacity of the material. However, an infinite dissipative capacity is not desirable for all applications. Thus, floors should on the one hand have a sufficiently low resistance that electrostatic charges cannot arise, but on the other hand the resistance must not fall below a predetermined value in order to exclude the harmful flow of current through the human body on touching a voltage source. A guide value for the dissipative capacity of floorcoverings is usually a resistance of ≦10⁹Ω.

DE 695 25 902 T2 discloses pigment granules comprising plastic materials which have at least three layers of plastic material. The interlayers are not visible through the surface layers, have a different colour to the surface layers and are formed from an electrically conductive film. The granules are used as floor- or wallcovering in the form of a film. This film is produced from the granules by thermal treatment and pressing, with the electrically conductive interlayers being connected to one another in the form of a conductor network by the film production process. A film produced in this way can be used as floor- or wallcovering which is able to dissipate static discharges. In order that at least one interlayer is formed with electrical conductivity properties, these interlayers may be interspersed with carbon black, where the graphite constituent of carbon black contributes to the conductivity of the interlayer.

DE 42 12 950 A1 describes conductive pigments which consist of a component A and a component B. Component A consists of one or more conductive, flake-form pigments, while components B consists of one or more conductive non-flake-form pigments. In order to form conductivity, the flake-form and non-flake-form pigments are provided with a conductive surface layer which consists of conductive metal oxides or metal oxide mixtures. A conductive layer of antimony-doped tin oxide is preferably used. The flake-form support material employed is flake-form effect pigments, such as, for example, natural or synthetic mica, phyllosilicates or glass flakes. The non-flake-form pigments employed can be spherical or cuboid support materials. Particular preference is given to the use of pigments coated with antimony-doped tin oxide. Conductive flake-form pigments of this type are commercially available from Merck KGaA, Darmstadt, under the name Minatec®. Conductive coatings can be produced from these conductive pigments comprising at least one component A and/or at least one component B. The advantage of Minatec® pigments consists in the production of pale, dissipative coating materials, in the case of which the use of conductive carbon black and graphite constituents is not suitable, owing to the black, dark base shade of the carbon black and graphite constituents.

Further conductive pigments or pigment granules would now be desirable from which conductive coatings, for, for example, floorcoverings, can be produced less expensively, but which nevertheless have dissipative capacities in the range 10³-10⁹Ω and have a pale colour. This enables the range of applications of conductive pigments and pigment granules to be expanded.

Surprisingly, it has now been found that pigment granules based on a support material, such as, for example, polymer particles, glass beads, hollow glass beads or the like, which have been coated with one or more electrically conductive pigment, have the desired dissipative capacity and from which less expensive materials for surface coating can be produced owing to the reduced content of conductive pigment.

In one aspect of the invention, pigment granules are thus proposed which are based on at least one support material coated with at least one electrically conductive pigment by means of at least one adhesion promoter.

By coating at least one support material with at least one electrically conductive pigment, the proportion of electrically conductive pigment in an electrically conductive dielectric material can advantageously be reduced without the dissipative capacity being drastically impaired. The material can thus be produced using less material and thus more economically, since smaller amounts of the electrically conductive pigment can be used. The reduced concentration of electrically conductive pigment enables paler conductive materials to be formulated with the granules according to the invention or conductive articles to be designed with decors in attractive colours.

Coated here is taken to mean the surface coating of the at least one support material with the at least one electrically conductive pigment. The at least one electrically conductive pigment is fixed to the surface of the support material by physical forces and/or the adhesion promoter. A proportion of electrically conductive pigment can also be in loose form and in a form not fixed to the surface.

The term “granules” in this application is taken to mean all solid particle shapes which are conceivable to the person skilled in the art, such as, for example, pellets, briquettes, pearlets, sausages or the tabletted form. The particle sizes of the granules are preferably in the range from 0.025 to 150 mm, in particular 0.1 to 20 mm, and very particularly preferably in the range from 0.05 to 6 mm.

The lightness of materials and thus also the lightness of the pigment granules according to the invention and the materials which can be produced therefrom, which may in addition have a coloured design, can be determined by means of a colour system. Colour systems of this type combine the information of the three elements light source, observer and object, enabling the materials to be described using colour systems of this type, for example with respect to their colour, their colour difference and their lightness. Thus, for example, the L*a*b* colour system of the CIE (Commission Internationale de l'Eclairage) enables the determination of the lightness of a material. In this colour system, L* stands for the lightness, where a value of 100 references a white colour, while a value of 0 stands for the colour black. The green/red axis is indicated by means of the a* value, while the blue/yellow axis is denoted by the b* value. The respective material can now be measured using corresponding suitable colour measurement equipment and the lightness L* can be determined in the course of this.

The conductive, pale pigment granules according to the invention preferably themselves have a lightness or L* value of at least 40, in particular at least 50, very particularly preferably at least 60 and even at least 80.

The pale materials produced using these conductive pigment granules according to the invention can have a lightness or L* value of at least 40, in particular at least 50, for example at least 60 and optionally even at least 80.

As essential constituent, the pigment granules comprise at least one electrically conductive pigment. An electrically conductive pigment is taken to mean a pigment that is able to conduct the electrical current, for example in the case of discharge of a static charge. The electrically conductive pigment has a resistance value which enables such a discharge of the electrical current at least over the surface of the pigment body. The electrical conductivity of the individual pigment bodies amongst one another occurs due to contact of the pigment bodies with one another in the pigment granules or in an embodiment comprising the pigment granules. The electrically conductive pigment may consist entirely of a conductive material, or of a pigment support material provided with a conductive coating. In the case of a pigment support material provided with an electrically conductive coating, a further cost reduction can advantageously be achieved. Electrically conductive pigments can preferably be in flake form, or have a non-flake-form formation. In the case of the non-flake-form formation, the electrically conductive pigments can have a needle-shaped, angular or square shape. It is also possible to employ mixtures of different conductive pigments.

For example, at least one electrically conductive pigment can be selected from the following group:
support-free or support-containing metal oxide-containing pigments
support-free or support-containing metal-containing pigments
conductive polymers
graphite
carbon nanotubes
nanosilver, or
any desired mixture thereof.

If electrically conductive pigments of this type are processed together with a support material and optionally an adhesion promoter to give pigment granules, the proportion of electrically conductive pigment can be significantly reduced without the dissipative capacity of the pigment granules, even in processed form, suffering significantly as a result. The requirement for wetting agents for wetting the electrically conductive pigments can thus be reduced, enabling the rheological properties, such as pumpability and/or sprayability, flow properties and leveling ability, during processing of the pigment granules to be improved. In addition, the dust nuisance during further processing can be significantly reduced on use of pigment granules having a reduced content of electrically conductive pigment, enabling the use in the building site area to be extended.

Flake-form pigment support materials which can be employed are mica, kaolin, talc, metal flakes or polymer flakes. Flake-form pigment support materials which can be employed are also all flake-form effect pigments, such as, for example, flake-form iron oxide, bismuth oxychloride, or flake-form materials coated with coloured or colourless metal oxides, such as, for example, natural or synthetic mica, sericite and other phyllosilicates, such as talc or kaolin, glass flakes, Al₂O₃ flakes or SiO₂ flakes. The flake-form pigment support material employed can also be mica flakes coated with metal oxides. Metal oxides which can be used here are both colourless high-refractive-index metal oxides, such as, for example, titanium oxide or zirconium dioxide, and also coloured metal oxides, such as, for example, chromium oxide, nickel oxide, copper oxide, cobalt oxide and in particular iron oxides, such as, for example, Fe₂O₃ or Fe₃O₄, or mixtures of such metal oxides. Metal oxide/mica pigments of this type are commercially available under the trade name Afflair® and Iriodin® (Merck KGaA, Darmstadt). These and further support materials are known from the patent specifications U.S. Pat. No. 3,087,828, U.S. Pat. No. 3,087,829, EP 14382, EP 68311, EP 265820, EP 268072 and EP 283852.

The conductive component of the pigment can consist of one or more metal oxides, metals or other conductive compounds, for example iron sulfide or polymers, such as polyacetylene. The conductive layer is applied in a manner known per se, for example by the process described in EP-A 139557. All possible conductive metal oxides or metal-oxide mixtures can be employed here. A selection of such materials is known from EP-A 139557. However, it is also possible to employ conductive pigments which consist entirely of a conductive material.

Pigment support materials, in particular in flake form, which are coated with antimony-doped tin oxide can preferably be employed. These are commercially available from Merck KGaA, Darmstadt, under the name Minatec®. Furthermore, it is also possible to employ pigment mixtures comprising flake-form, conductive pigments and non-flake-form, conductive pigments, as known from DE 42 12 950 A1.

Conductive polymers which can be employed are electrically self-conducting polymers, such as, for example, polyacetylenes, polyanilines, poly-paraphenylenes, polypyrroles or polythiophenes. Polyethylenedioxythiophene (PEDOT), which is available, for example, from Kodak under the trade name Orgacon, can preferably be employed.

Carbon nanotubes which can be used are, for example, carbon nanotubes from Arkema available under the trade name Graphistrength CW 1-20″. These carbon nanotubes contain 20% of MWCNT (“multiwall carbon nanotubes”) and are particularly suitable for water-based applications.

Metals which can be employed are all conceivable metals which are stable in the respective application. Preference is given to the use of nanometals and preferably nanosilver as well as a nanosilver dispersion.

Furthermore, pale, electrically conductive pigments can be employed. Accordingly, these pale, electrically conductive pigments can advantageously be used to produce pigment granules which have a pale colour. The colour of the pigment granules or of the pale, electrically conductive pigments is preferably white or pale grey. However, the pigment granules, or pigments, may also have other shades, such as, for example, a yellow shade, a pale-green shade, a pale-blue shade, an ochre shade or other shades from the RAL colour range. The use of pale, electrically conductive pigments advantageously enables a rather dark colour, as is known in the case of the use of graphite or carbon black, to be shifted to paler shades. This shift to pale shades can be set specifically by means of the pale, electrically conductive pigments.

The proportion of electrically conductive pigment in the pigment granules is preferably 1-20% by weight, preferably 1-15% by weight and in particular 5-10% by weight, based on the granules.

Accordingly, the proportion of electrically conductive pigment can advantageously be significantly reduced by the use of support materials coated with the electrically conductive pigments compared with pigment granules without support materials of this type, where the same or a comparable dissipative capacity of the pigment granules occurs compared with pigment granules without support materials.

As further essential constituent besides the electrically conductive pigments, the pigment granules also comprise at least one support material. Support material here is taken to mean the constituent of the pigment granules on which the electrically conductive pigment is coated by means of the adhesion promoter. A suitable support material may have high transparency and a smaller size compared with the electrically conductive pigment. The support materials can be in the form of individual particles.

At least one support material here can be in non-flake form, in particular spherical form.

The occupation of a larger volume by the support material is advantageously thereby possible, where the dissipative capacity of the pigment granules is furthermore provided by the coating of the support material with the at least one electrically conductive pigment. The support material here can be in spherical form or in non-round form, for example such as broken chippings, and can thus have corners and edges.

In addition, at least one support material may also be in electrically conductive form. In addition, the support material may have been made more conductive than the coating comprising the electrically conductive pigments.

Conduction of the electrical current through the support material can thus advantageously occur.

Furthermore, at least one support material can be a polymer particle, a solid glass bead, a hollow glass bead, an amorphous or crystalline silicon dioxide, ground ceramic granules and/or a solid ceramic bead, for example ground solid steatite bead. The polymer particles here may likewise be in hollow or solid form. Accordingly, hollow polymer beads or solid polymer beads can be employed.

It is thus advantageously possible to employ less expensive materials compared with the electrically conductive pigments and thus to reduce the material costs of the pigment granules. In the case of ceramic support materials, resistance to corrosive effects of the atmosphere, even in the presence of salt-, acid- and alkali-containing media, gases, vapours and precipitates, is additionally present.

Thus, the support material employed can be solid glass beads and/or hollow glass beads. Preference is given here to solid glass beads and particularly preferably hollow glass beads.

In addition, transparent supports, such as, for example, solid glass beads and hollow glass beads, with their transparency to light can support the optical properties, for example the pearlescence or metal lustre, of the pigment granules.

The solid glass beads should be chemically resistant, depending on the area of application. Preference is given to the use of solid glass beads or hollow glass beads made from soda-lime glass (principal constituents: SiO₂/CaO/Na₂O), ECR glass, C glass borosilicate glass or quartz.

It is also possible to use mixtures of solid glass beads and hollow glass beads. All conceivable mixing ratios can be employed here, the support materials are preferably mixed in such a way that physical and chemical properties, such as adhesion in the application medium and resistance to chemicals, correlate with aesthetic effects and economic considerations.

Solid glass beads are commercially available, for example from Sovitec GmbH under the name Vialux or Microperl. The particle sizes can be determined here in accordance with DIN 66165-Part 2, 1987-04 edition. In the case of relatively small particle sizes, the determination can also preferably be carried out by means of static laser-light scattering, as described in ISO 13320, 2009/10 edition. The measurement principle used here is generally the Mie theory in accordance with ISO 13320, 2009/10 edition. The support particles used in the present patent application are determined by dry measurement by means of a Retsch particle analyser, “Horiba LA-950” model. Hollow glass beads can be purchased, for example, from 3M Deutschland GmbH under the trade name “3M Glass Bubbles” or from Omega Minerals Norderstedt under the trade name “Sphericel” or are available from Trelleborg Offshore Ltd. under the name “Fillite” and from Dennert Proaver under the name “Proaver”.

The solid glass beads should be chemically resistant, depending on the area of application. Solid glass beads or hollow glass beads made from soda-lime glass having the principal constituents SiO₂/CaO/Na₂O, ECR glass, C glass borosilicate glass or quartz, can preferably be used.

Hollow glass beads from 3M Deutschland GmbH can have the following characteristic values:

Oil absorption: 0.2-0.6 g of oil/cm³ (determined in accordance with ASTM 0281-95).

Particle size: 9-120 μm (determined in accordance with DIN 66165-2)

It is also possible to use hollow glass beads or solid glass beads made from soda-lime glass having the principal constituents SiO₂/CaO/Na₂O, ECR glass, C glass, borosilicate glass or quartz which have been coated or coloured with an organic or inorganic pigment.

In principle, all organic and inorganic pigments can be used for colouring or coating hollow glass beads or solid glass beads.

Thus, it is possible to use, for example, organic pigments, as described in “Industrielle Organische Pigmente” [Industrial Organic Pigments” by the authors Hunger/Herbst, published by VCH-Verlag 1995, on pages 633-640.

Furthermore, it is possible to use organic and inorganic pigments as described in “Pigment+Füllstofftabellen” [Pigment+Filler Tables] by the author Lückert, published by Vincentz-Verlag 2002, 6th Edition. Black pigments are described here on pages 407-434, white pigments on pages 72-94, red pigments on pages 216-299 and blue pigments on pages 326-361.

The coloured or coated hollow glass beads or solid glass beads can subsequently be coated on the surface with electrically conductive pigments.

It is also possible to use coloured hollow glass beads from Quadra Industries. These hollow glass beads used can have the following characteristic value:

Particle size: 15-65 μm (determined in accordance with DIN 66165-2). The solid glass beads from Quadra Industries are coated with either organic and/or inorganic pigments.

It is also possible to employ ceramic support materials, such as, for example, ground steatite granules and/or solid steatite beads. Ground granules here encompass non-round particles produced by means of a granulation process, while the solid beads encompass fully round beads with a pressed edge produced by the dry pressing process. Ground steatite granules and/or solid steatite beads of this type are commercially available from Mühlmeier, Bärnau, Germany.

The polymer particles employed are preferably those made from plastic(s), such as, for example, thermoplastics or thermosets. The polymer particles preferably consist of polyolefins, in particular of polyethylene (PE) and polypropylene (PP), polystyrene (PS), polymethyl methacrylate (PMMA), polyethylene terephthalate (PET), polycarbonate (PC), polyvinyl acetate copolymer (PVAC), polyvinyl chloride (PVC), ethylene-acrylic acid copolymer (EAA), ethylene-vinyl acetate copolymer or biodegradable polyesters, for example polylactic acid (polyactide=(PLA)).

Particularly preferred support materials consist of PVC, in particular of spherical granules, available, for example, from Geerkens Rohstoffe, Willich, Germany.

The commercially available plastic powders or plastic granules frequently have particle sizes of 1-5 mm. These polymer particles can be melted in advance during the production of the pigment granules according to the invention and then adjusted to the desired particle size and shape, for example by granulation, for example underwater granulation, and optionally adjustment of the particle size, for example by means of a perforated disc.

It is also possible to use mixtures of different support materials, such as, for example,

solid glass beads + hollow glass beads,
solid glass beads + thermoplastics,
solid glass beads + thermosets,
thermoplastics + thermosets + solid glass beads
hollow glass beads + thermoplastics
hollow glass beads + thermosets
thermoplastics + thermosets + hollow glass beads
thermoplastics + thermosets.

All conceivable mixing ratios can be employed here, the support materials are preferably mixed in such a way that physical and chemical properties, such as, for example, adhesion in the application medium and chemicals resistance, correlate with aesthetic effects and economic considerations.

The support material mixtures are preferably two-component mixtures, which can be mixed with one another in any mixing ratio. The ratio is preferably 1:1 to 1:10 or 10:1.

It is likewise possible to use unstructured particles of the same particle-size distribution. The support materials can be employed in any desired combination with one another for the pigment granules.

At least one support material can have a particle size of 0.01-100 mm, in particular 0.01-50 mm and optionally 0.1-10 mm. A particle size of 0.025-5 mm is preferred.

The larger the particle sizes, the more volume can advantageously be occupied by the support material in the pigment granules. The material costs of the pigment granules can thus be significantly reduced.

The proportion of support material, based on the pigment granules, can be 80-99% by weight. In particular, a proportion of 90-99% by weight is also possible. A proportion 80-90% by weight is preferred.

The requirement for wetting agent can advantageously be reduced thereby and the rheological properties during processing are improved. If sufficient support material is used, the desired properties of the pigment granules according to the invention, such as, for example, reduced dust behaviour and/or improved flowability, can be ensured. To this end, the polymer particles must not only have been coated with the electrically conductive pigment, but they must also be stuck to one another to form a readily flowable coarse “powder”.

The weight ratio of support material to electrically conductive pigment in the pigment granules can be from 1:5 to 50:1. For example, a weight ratio of 10:1 to 20:1 is preferred.

The pigment concentration is advantageously reduced thereby, but nevertheless a sufficiently high dissipative capacity is present. The weight ratio of support material to electrically conductive pigment can also be employed to control the dissipative capacity.

Pigment granules can preferably comprise at least one adhesion promoter. The adhesion promoter here can preferably be selected from the group:
ethylene-acrylic acid emulsion (EAA)
chlorinated or unchlorinated polypropylene dispersion,
chlorinated or unchlorinated polyethylene dispersion,
polyurethane dispersions,
wax emulsions.

Through the use of the adhesion promoter, the conductive pigment can advantageously be fixed to the support material, where it is thereby not excluded that some of the electrically conductive pigment is present in the granules in unfixed form. The fixing likewise enables the dust emission during processing of the pigment granules to be reduced.

Further suitable adhesion promoters are, in particular, those which dry physically. The adhesion promoters used are particularly preferably aqueous emulsions, preferably EAA emulsions (ethylene acrylic acid copolymers), commercially available, for example, from Michelman under the name “Michem Prime 4983 R”, and emulsions and dispersions based on acrylated polypropylenes or low-chlorinated polypropylenes. Emulsions and dispersions of this type are commercially available, for example from Tramaco under the name “Trapylen 9310 W” and “Trapylen 6700 W”.

The size of the EAA emulsion particles is preferably 20-300 nm. The EAA emulsions preferably used preferably consist of 65-85 parts of water and 15-35 parts of EAA.

The size of the acrylated polypropylene or low-chlorinated polypropylene emulsion particles or dispersion particles is preferably 50-5000 nm.

Suitable adhesion promoters are furthermore wax emulsions, which are commercially available, for example, from KEIM ADDITEC Surface GmbH. Suitable wax emulsions are, for example, LD-PE wax emulsions (LD-PE=low-density polyethylene), for example Ultralube V-06070480 from KEIM ADDITEC Surface GmbH. The wax emulsions preferably comprise emulsion particles having a size of 20-100 nm. The suitable wax emulsions preferably have a melting range of 50-160° C., in particular 90-140° C. and very particularly preferably 90-130° C.

Furthermore suitable adhesion promoters which are based on aqueous dispersions are mentioned below, such as, for example, those

1) based on copolymers or based on terpolymers:
vinyl acetate (VAC)/(ethylene) [E]=VAC/E
vinyl acetate (VAC)/(ethylene) [E]/vinyl chloride (VC)=VAC/E/VC
vinyl chloride (VC)/ethylene [E]/acrylate (AY)=VC/E/AY
vinyl chloride (VC)/ethylene [E]/vinyl laurate (VL)=VC/E/VL
vinyl acetate (VAC)/(ethylene) [E]/vinyl chloride (VC)=VAC/E/VC

2) based on acrylate dispersions
styrene-acrylate (S-AY)
acrylate (AY)
self-crosslinking acrylate
polyacrylates and copolymers thereof
PMMA and copolymers thereof

3) dispersions based on the composition:
Versatic acid vinyl ester (VeoVa)/acrylate (AY)=VeoVa/AY
ethylene copolymer/acrylate=e-copol./AY
aqueous polyvinylbutyral dispersions=PVB
aqueous polyvinyl propionate dispersions=PVP
water-dilutable urea resins
water-dilutable polyesters
water-dilutable alkyd resins
water-dilutable colophony resins and colophony resin esters
water-dilutable shellac
water-dilutable polyvinyl acetals
water-dilutable polyvinyl ethers
water-dilutable soya proteins
polyvinyl alcohols=PVOH

4) polyurethane dispersions

4a) aliphatic polyurethanes
polyether (PE)/polyurethane (PU)=PE/PU
polyester (PES)/polyurethane (PU)=PES/PU
polycarbonate (PC)/polyurethane (PU)=PC/PU
polyester (PES)/polycarbonate (PC)/polyurethane (PU)=PES/PC/PU

4b) aliphatic oil-based polyurethane hybrids
based on castor oil (CO)
based on castor oil and linseed oil (LO)

Suitable adhesion promoters are furthermore adhesives based on resins and polymers which can be diluted with organic solvents or are soluble therein. These adhesion promoters are usually not water-soluble or water-dilutable. Examples of suitable raw materials are given, for example, in Lackrohstofftabellen [Coating Raw Materials Tables], Vincentz-Verlag, 10th Edition, 2000 edition, pages 62-622.

Examples of possible adhesives which can be used as adhesion promoter are generally based on the following resins and polymers:
saturated polyesters
unsaturated polyesters
epoxides
polyacrylates and copolymers
PMMA and u.-copolymers
polyamides
ketone resins and aldehyde resins
polystyrenes
polyurethanes (PU)
polyurethanes (PU)/acrylates (AY)=(PU/AY)
moisture-curable polyurethanes
PVC
polyvinyl acetates
polyvinyl acetals
polyvinyl ethers
alkyd/melamine
urea resins
polyvinylbutyral=PVB
polyvinyl propionate=PVP
urea resins
polyester resins
alkyd resins
colophony resins and colophony resin esters
shellac

The adhesives which can be employed as adhesion promoters are divided in accordance with the solidification mechanism into:

1. polymerisation adhesives, such as, for example,
cyanoacrylate (CY-AY)
MMA adhesives (MMA=methyl methacrylate)
anaerobically curing adhesives
radiation-curing adhesives

2. polycondensation adhesives, such as, for example,
phenol-formaldehyde adhesives
silicone adhesives
silane-crosslinking polymer adhesives
polyimide adhesives

3. polyaddition adhesives, such as, for example,
epoxy resin adhesives
polyurethane adhesives

4. hot-melt adhesives, such as, for example,
moisture-reactive amorphous poly-alpha-olefin hot-melt adhesive=1C APAO.

The proportion of adhesion promoter, based on the pigment granules, can be 0.05-20% by weight. For example, a proportion of 0.1-20% by weight, in particular 0.1-15% by weight and optionally 0.1-10% by weight, is also possible. A proportion of 0.5-10% by weight is preferred.

The indicated proportions of adhesion promoter in the pigment granules advantageously enable good adhesion of the electrically conductive pigment to the support material to be achieved, so that only a little unbound, electrically conductive pigment is present in the pigment granules.

The at least one support material, the at least one electrically conductive pigment and the at least one adhesion promoter can be balanced with one another in terms of colour in such a way that the pigment granules or the application form which can be prepared therefrom, as described below, have or has a pale colour.

Pigment granules may additionally comprise at least one additive, as are usual for use in application media from the areas of paints, coatings, powder coatings, plastics or the like. Additives and/or assistants of this type can be lubricants, release agents, stabilisers, antistatics, flameproofing agents, antioxidants, colorants, flexibilisers, plasticisers, such as, for example, diisononyl phthalate, adhesion promoters, blowing agents, antioxidants, UV absorbers, inorganic fillers and/or surfactants, organic polymer-compatible solvents and/or surfactants, phenol derivatives, mineral oils. An overview of the additives and assistants which can be employed is given in Saechtling, Kunststoff Taschenbuch [Plastics Pocketbook], 27th Edition, Carl Hanser Verlag, or is given by R. Wolf in “Plastics, Additives” in Ullmann's, Encyclopaedia of Industrial Chemistry, Internet edition, 7th Edition, 2003.

The use of additives enables the properties of the pigment granules to be influenced in an advantageous manner, so that the range of uses of the pigment granules can be expanded.

The pigment granules particularly preferably comprise wetting agents, for example silicones, silanes and/or fluorosurfactants.

The proportion of additive in the pigment granules can be 0.05-10% by weight, based on the granules. For example, a proportion of 0.1-10% by weight, in particular 0.1-5% by weight and optionally 0.1-5% by weight, is also possible. A proportion of 0.5-5% by weight is preferred.

Support material, adhesion promoter and electrically conductive pigment can be present in pigment granules in a weight ratio of 8:1:1 to 9.5:0.25:0.25. The weight ratio is preferably from 8.5:0.5:1.

Furthermore, pigment granules may preferably comprise
1-20% by weight of one or more electrically conductive pigments
80-90% by weight of one or more support materials
1-5% by weight of adhesion promoters
0-5% by weight of additive(s), preferably 1-5% by weight of additive(s),

based on the entire recipe of the pigment granules, where the total proportion of all components in the pigment granules is 100% by weight.

Pigment granules may also comprise at least one filler, at least one dye and/or at least one coloured pigment, in particular those which are usual in the area of plastics and/or paints. Based on the pigment granules, where the total proportion of all components is 100% by weight, the proportion of dye, coloured pigment and/or filler can be up to 10% by weight.

Fillers of this type are described in “Pigment+Füllstofftabellen” [Pigment+Filler Tables] by the author Lückert, published by Vincentz-Verlag 2002, 6th Edition, on pages 596-768.

The use of at least one filler, at least one dye and/or at least one coloured pigment enables desired properties, such as, for example, a colour shade, of the pigment granules to be set specifically. The conductive granules can thus be matched in terms of colour to the requirements in the application. For example, the addition of white pigments or fillers is advantageous if a pale colour is required in the application.

In a further aspect of the invention, a process is proposed for the production of pigment granules in which at least one electrically conductive pigment and at least one support material are mixed simultaneously or successively with one another with at least one adhesion promoter and optionally at least one additive, filler, dye and/or coloured pigment.

Pigment granules can be produced relatively easily. Possible production processes which may be mentioned are gentle mixing of the individual components, comprising an electrically conductive pigment, support material, adhesion promoter, optionally colorants and/or further additives, and subsequent rotogranulation. In this case, the components to be mixed are mixed using a mixer, in which the support material, the adhesion promoter and optionally additives and the electrically conductive pigment or the mixture of electrically conductive pigments and optionally further organic and/or inorganic pigments are mixed. In the next step, the granules are rounded to the intended particle size on a horizontally rotating pelletising pan. Finally, the crude granules are dried gently in a turbulent bed, for example in a fluidised-bed or turbulent-bed drier. However, performance in a turbulent-bed drier is preferred.

The sequence of addition of electrically conductive pigment, adhesion promoter and support material is variable and can also be carried out, for example, by initially introducing the electrically conductive pigment and subsequently mixing it with the adhesion promoter, the support material and optionally additives and/or colorants. This procedure is particularly preferred.

It is likewise possible to initially introduce the electrically conductive pigment, the support material and optionally additives and subsequently to add with the adhesion promoter.

In the pigment granules according to the invention, the electrically conductive pigments, the support material and the adhesion promoter and optionally additives are in the form of a mixture with one another. The support material is preferably at least partially or completely coated or covered with the electrically conductive pigment by means of the adhesion promoter. Complete coating with and “sticking” of the support material to the electrically conductive pigment is very particularly preferred.

As a further aspect of the invention, the use of the pigment granules in printing inks, paints, coatings, powder coatings, surface coatings, plastic applications and/or plastics is proposed. Particular preference is given here to the use of the pigment granules according to the invention in flooring and/or as PVC coating.

As a further aspect of the invention, a surface coating comprising pigment granules is proposed, where the pigment granules comprise a support material which has been coated with at least one electrically conductive pigment by means of an adhesion promoter.

The pigment granules according to the invention advantageously enable the formation of a pale surface coating. This pale surface coating is in addition conductive, abrasion-resistant and, owing to the use of only a small proportion of electrically conductive pigment, correspondingly inexpensive. A surface coating of this type can preferably be applied to one of the following elements: a floor, a garage floor, a floor in the medical sector, a floor in laboratories, a floor in workshops or assembly halls, a floor in chip production or the like.

The surface coating is preferably white to pale grey and optionally colour-tinted, in accordance with the RAL colour range.

The surface coating can have a dissipative capacity value of 10³ to 10⁹ ohm.

The following examples are intended to explain the invention in greater detail, but without limiting it.

### EXAMPLES

### Example 1

### Production of Conductive Pigment Granules Comprising PVC

For the production of the pigment granules according to the invention, homogeneous mixing must be ensured. The mixture is prepared with the aid of an Eirich R02 mixer.

To this end, 1000 g of spherical, 1 mm PVC granules (Geerkens Rohstoff GmbH, Willich, Germany) and 110 g of Minatec® 60 CM (mica flakes coated with antimony oxide+tin oxide; Merck KGaA) are initially introduced in the mixing container and mixed for 3 min at setting 1 for pan and fluidiser of the Eirich R02 mixer. 65 g of an aqueous polycarbonate/polyurethane dispersion (Alberdingk & Boley, Krefeld, Germany, solids content: 37-39%, pH: 7.5-9, elongation at break=200%) are then slowly added with stirring to the plastic/pigment mixture prepared in advance and mixed homogeneously for 1 min at setting 1 of the Eirich R02 mixer Eirich R02 mixer 1 for pan and fluidiser.

The moist plastic/pigment/polymer mixture prepared in this way is pelletised in an Eirich TR 04 pelletising pan, where the size distribution is also established.

To this end, 200 g of freshly produced granules are placed on the pan, and the target particle size is established at 200-350 rpm and a tilt angle of 30-40°. When the target particle size has become established, the introduction of the total amount, of the water-moist pigment/adhesion promoter/plastic batch in portions is begun.

The target size is controlled, in particular, by the dimensions (size in mm) of the plastic granules employed and is intended to grow to 2±0.5 mm in the pre-specified experiment.

Portions between 50-100 g are introduced here, which can be added within a short time (1 kg about 10-15 min). Larger aggregates accumulate in the centre of the “material-flow kidney” formed during pelletisation. These are taken up using a small shovel, comminuted by hand and re-added.

The moist, granulated mixture is dried for 10-30 min. at 40-60° C. in a fluidised-bed drier. The granules produced in this way are protectively classified via a sieve having a mesh width of 3.55 mm.

The pigment granules obtained in this way vare abrasion-resistant and dimensionally stable.

### Example 2

### Production of Soft PVC Pressings

Pressings A, B, C, D produced have the following dimensions:

Length: 20 cm; width: 15 cm; thickness: 5 mm.

Production of Pressing A:

90 g of Decelith 76000 PVC granules (PCW, Eilenburg, Germany)+90 g of granules from Example 1 are pressed at 145° C. for 2.5 min in a Collin thermopress at a pressure of 80 bar and subsequently cooled for 2 min.

Production of Pressing B:

95 g of Decelith 76000 PVC granules (PCW, Eilenburg, Germany)+95 g of granules from Example 1 are pressed at 145° C. for 2.5 min in a Collin thermopress at a pressure of 80 bar and subsequently cooled for 2 min.

Production of Pressing C:

150 g of Decelith 76000 PVC granules (PCW, Eilenburg, Germany)+50 g of granules from Example 1 are pressed at 145° C. for 2.5 min in a Collin thermopress at a pressure of 80 bar and subsequently cooled for 2 min.

Production of Pressing D (Comparative Experiment):

150 g of Decelith 76000 PVC granules (PCW, Eilenburg, Germany)+50 g of Minatec® 60CM (Merck KGaA) are pressed at 145° C. for 2.5 min. in a Collin thermopress at a pressure of 80 bar and subsequently cooled for 2 min.

### Example 3

### Measurement of Soft PVC Pressings A, B, C, D

The surface resistances are determined in accordance with DIN-EN-61340-2-3, “Electrostatics” of December 2000. The visual colour impression of the coating is determined.

| | | Use concentration | Surface resistance R |
|---|---|---|---|
| Pressing | Colour | [%] | [kΩ] |
| A | pale grey | 4.50 | 20.0 |
| B | pale grey | 4.50 | 15.0 |
| C | pale grey | 2.25 | 5.7 |
| D | pale grey | 25.00 | 5.3 |

The use concentration [%] here is taken to mean the percentage of conductive pigment in 100 g of the entire recipe of conductive PVC flooring material.

The experimental series shows that pigment granules according to the invention enable the percentage of electrically conductive pigment to be reduced by a factor>10 with approximately constant surface resistance. In addition, the colour of the pressing increases with increasing pigment content, so that pressing C has the palest shade, followed by A and B. Pressing D has the comparatively darkest shade.

1. Pigment granules, characterised in that they are based on at least one support material coated with at least one electrically conductive pigment by means of at least one adhesion promoter.

2. Pigment granules according to claim 1, characterised in that at least one electrically conductive pigment is selected from the group:
support-free or support-containing metal oxide-containing pigments
support-free or support-containing metal-containing pigments
conductive polymers
graphite
carbon nanotubes
nanosilver, or
any desired mixture thereof.

3. Pigment granules according to claim 1, characterised in that at least one support-free or support-containing metal oxide-containing pigment is a tin oxide-containing pigment.

4. Pigment granules according to claim 1, characterised in that the proportion of electrically conductive pigment in the pigment granules is 0.1-20% by weight.

5. Pigment granules according to claim 1, characterised in that at least one support material is in non-flake form, in particular spherical form.

6. Pigment granules according to claim 1, characterised in that at least one support material is formed with electrically conductive properties.

7. Pigment granules according to claim 1, characterised in that at least one support material is a polymer particle, a solid glass bead, a hollow glass bead, an amorphous or crystalline silicon dioxide, ground ceramic granules and/or a solid ceramic bead, ground steatite granules and/or a ground solid steatite bead.

8. Pigment granules according to claim 1, characterised in that at least one support material has particle sizes of 0.01-100 mm.

9. Pigment granules according to claim 1, characterised in that the proportion of support material, based on the pigment granules, is 80-99% by weight.

10. Pigment granules according to claim 1, characterised in that the weight ratio of support material to electrically conductive pigment in the pigment granules is from 1:5 to 50:1.

11. Pigment granules according to claim 1, characterised in that the adhesion promoter is selected from the group
ethylene-acrylic acid emulsion (EAA)
chlorinated or unchlorinated polypropylene dispersion
chlorinated or unchlorinated polyethylene dispersion
wax emulsion
polyurethane dispersion.

12. Pigment granules according to claim 1, characterised in that the proportion of adhesion promoter, based on the pigment granules, is 0.05-20% by weight.

13. Pigment granules according to claim 1, characterised in that the pigment granules comprise
1-20% by weight of one or more electrically conductive pigments
80-90% by weight of one or more support materials
1-5% by weight of adhesion promoters
0-5% by weight of additive(s),
based on the entire recipe of the pigment granules, where the total proportion of all components in the pigment granules is ≦100% by weight.

14. Process for the production of pigment granules according to claim 1, characterised in that at least one electrically conductive pigment and at least one support material are mixed simultaneously or successively with one another with at least one adhesion promoter and optionally at least one additive, filler, dye and/or coloured pigment.

15. A printing ink, paint, coating, powder coating, surface coating, plastic application or plastic containing pigment granules according to claim 1.

16. Surface coating comprising pigment granules, in particular according to claim 1, where the pigment granules comprise a support material which has been coated with at least one electrically conductive pigment by means of an adhesion promoter.

17. Surface coating according to claim 16, characterised in that the surface coating has a dissipative value of 10³ to 10⁹ ohm.
